(19) United States
(12) Patent Application Publication
(10) Pub. No.: US 2025/0281893 A1
(43) Pub. Date: Sep. 11, 2025

(54) FLOATING SUPPORT GRID SYSTEM FOR HORIZONTAL AMMONIA CONVERTER BASKET CATALYST BED

(71) Applicant: KELLOGG BROWN & ROOT LLC, Houston, TX (US)

(72) Inventors: Sachin Sadanandan Kalatrakkal, Houston, TX (US); Dinesh Umanbath Prabhu, Maharashtra (IN); Vishvajeet Keshavrao Joshi, Maharashtra (IN); Ravi Dayaram Mahatale, Maharashtra (IN)

(73) Assignee: KELLOGG BROWN & ROOT LLC, Houston, TX (US)

(21) Appl. No.: 19/074,123

(22) Filed: Mar. 7, 2025

(30) Foreign Application Priority Data
Mar. 8, 2024 (IN) 202411016961

(51) Int. Cl. B01J 8/02; B01J 19/32; C01C 1/04

(52) U.S. Cl. CPC B01J 8/0292; B01J 8/0278; B01J 19/325; C01C 1/0435; B01J 2208/00884; B01J 2219/32286

(57) ABSTRACT

A floating support grid system including a plurality of support beams and a plurality of profile wire screen panels wherein the support beams are connected to the profile wire screen panels via one or more first floating connections, wherein the support beams are configured to connect to a horizontal ammonia converter basket via one or more second floating connections, and wherein at least some the profile wire screen panels are configured to connect to a horizontal ammonia converter basket via one or more third floating connections, wherein each of the first, second, and third floating connections independently defines one or more gaps to accommodate movement caused by thermal expansion.

### CROSS REFERENCE TO RELATED APPLICATION

This application claims priority to India Application No. 202411016961, filed Mar. 8, 2024, which is incorporated by reference herein.

### FIELD OF THE INVENTION

The present invention relates to a floating support grid system. In examples, the disclosure herein relates to a floating support grid system for a horizontal ammonia converter basket catalyst bed.

### DISCUSSION OF THE RELATED ART

A horizontal ammonia converter basket is a key component in the process of synthesizing ammonia through the Haber-Bosch process. It consists of a cylindrical vessel typically made of stainless steel, horizontally oriented, and filled with catalyst material. The catalyst material, often based on iron with promoters like alumina and potassium oxide, facilitates the conversion of nitrogen and hydrogen into ammonia.

The reactants, nitrogen, and hydrogen, are passed through the catalyst bed under high pressure and temperature, typically ranging from 150 to 300 atmospheres and 350° C. to 500° C., respectively. The catalyst promotes the desired chemical reaction, producing an ammonia-rich product stream.

Horizontal converter baskets are used in large-scale industrial ammonia production plants due to their efficiency and scalability. They allow for continuous operation and high throughput of ammonia synthesis, crucial for meeting the demands of various industries reliant on ammonia as a feedstock for fertilizers, chemicals, and other applications. In a horizontal ammonia converter basket, catalyst supports play a crucial role in facilitating the ammonia synthesis reaction. Their primary function is to provide a stable structure for the catalyst bed, ensuring uniform distribution of the catalyst material throughout the basket. Additionally, these supports help optimize the surface area available for the catalytic reaction, enhancing the efficiency of ammonia production. The design of the catalyst supports in a horizontal converter basket is essential for maintaining optimal reaction conditions and maximizing the conversion of reactants into ammonia.

The catalyst in a horizontal converter basket is typically supported by a support grid system. In known systems, the catalyst support grid system has a profile wire screen with integral beams that act as a single unit. In case of mal-operational or severe plant upsets, the support grid system is subjected to rapid changes in temperature (beyond permissible range). In such a scenario, the beams are required to expand and move within the catalyst bed. Such expansions and movements may be resisted by the catalyst leading to resistance and excessive stresses in the support grid system consequently leading to failure of the support grid system. Also, catalyst containment structure is often provided using cover plates near the wall, partition plates, and/or end plates. These cover plates are in direct contact with the profile wires. During thermal expansion of the support grid system, the profile wires may not slide under the cover plates and may get stuck, which is undesirable.

When a plant experiences frequent upsets, the current support grid system with profile wire screens welded to beam is subjected to excessive thermal loads. These high thermal loads can lead to failure of the profile wire screen panel or the weld-joints between the beam and the profile wire screen panel.

Thus, an improved catalyst support grid system can be useful in providing a more stable structure.

### SUMMARY

Examples of floating support grid system can substantially obviate one or more of the problems due to limitations and disadvantages of the related art or at least to provide the public with a useful alternative.

Additional features and advantages of the examples as described herein will be set forth in the description which follows, and in part will be apparent from the description, or may be learned by practice of the examples described herein. The objectives and other advantages will be realized and attained by the structure particularly pointed out in the written description and claims hereof as well as the appended drawings.

To achieve these and other advantages and in accordance with examples described herein, as embodied and broadly described, is a floating support grid system and a horizontal ammonia converter including a floating support grid system.

In examples, disclosed herein is a floating support grid system that may include a plurality of support beams; a plurality of profile wire screen panels; a plurality of first connections each connecting one support beam of the plurality of support beams to one profile wire screen panel of the plurality of profile wire screen panels, wherein, at least one first connection of the plurality of first connections may include a first floating connection configured to define a first gap between the one support beam of the plurality of support beams and the one profile wire screen panel of the plurality of wire screen panels the at least one first connection connects; and a plurality of second floating connections each configured to connect a support beam of the plurality of support beams to a horizontal ammonia converter basket.

In examples, the first gap may be configured to accommodate a thermal expansion movement of a profile wire screen panel, a support beam, or both.

In examples, each first floating connection may connect one side of the one profile wire screen panel to one side of the one support beam.

In examples, at least one profile wire screen panel of the plurality of profile wire screen panels may be connected to a first support beam of the plurality of support beams at a first lateral side of the at least one profile wire screen panel and may be connected to a second support beam of the plurality of support beams at a second lateral side, opposite the first lateral side, of the at least one profile wire screen panel.

In examples, one first floating connection may be provided to connect the first support beam with the at least one profile wire screen panel at the first lateral side, and another first floating connection may be provided to connect the second support beam with the at least one profile wire screen panel at the second lateral side.

In examples, every first connection may include a first floating connection.

In examples, each profile wire screen panel of the plurality of wire screen panels may include a wire grid may include one or more wires; at least one support bar provided below the wire grid; and a built-in plate over a peripheral area of the wire grid.

In examples, the first floating connection further including a first cover plate configured to overlap at least a portion of the built-in plate over the peripheral area of the wire grid of the one profile wire screen panel connected to the one support beam, wherein the first cover plate may extend from the one support beam toward the one profile wire screen panel connected to the one support beam.

In examples, the floating support grid system may include the one or more cleats extending from a vertical web portion of the one support beam connected to the one profile wire screen panel to a top surface of the first cover plate.

In examples, the first floating connection further may include a first anti-lift system, wherein the first anti-lift system may include an anti-lift bar fixed connected to a bottom surface the one profile wire screen panel, the anti-lift bar configured to extend below a bottom surface of a base portion of the one support beam connected to the one profile wire screen panel. In examples, one or more stoppers extending from the base portion of the one support beam may be connected to the one profile wire screen panel, the one or more stoppers may be arranged to be on one or more lateral sides of the first anti-lift system to prevent lateral movement of the one profile wire screen panel relative to the one support beam connected thereto.

In examples, the floating support grid system may include one or more third floating connections configured to connect at least one profile wire screen panel of the plurality of wire screen panels to the horizontal ammonia converter basket, wherein each third floating connection may be configured to define a third gap between the at least one profile wire screen panel and a third or fourth portion of the horizontal ammonia converter basket it may be configured to connect when the at least one profile wire screen panel may be connected to the horizontal ammonia converter basket. In examples, the third gap may be configured to accommodate a thermal expansion movement of the at least one profile wire screen, a support beam of the plurality of support beams, or both. In examples, every third floating connection may include a second cover plate arranged to extend over the third gap defined by third floating connection; and a second anti-lift system.

In examples, at least one second floating connection of the plurality of second floating connections may be configured to define one or more second gaps between the support beam of the plurality of support beams and a second one or more portions of the horizontal ammonia converter basket when the at least one second floating connection connects a lateral end of the support beam of the plurality of support beams to the horizontal ammonia converter basket.

In examples, each of the one or more second gaps may be configured to independently accommodate a thermal expansion movement of the support beam of the plurality of support beams, a profile wire screen panel of the plurality of profile wire screen panels, or both.

In examples, the support beam of the plurality of support beam may include a first lateral end and a second lateral end, opposite the first lateral end, and wherein one second floating connection may be arranged to connect the first lateral end to the horizontal ammonia converter basket and another second floating connection may be arranged to connect the second lateral end to the horizontal ammonia converter basket.

In examples, every support beam of the plurality of support beams may include a respective first lateral end with a respective second floating connection and a second lateral end, opposite the first lateral end, with a respective second floating connection, wherein every first lateral end and every second lateral end are connected to the horizontal ammonia converter basket.

In examples, the second floating connection may be configured to define a panel lateral side gap between a profile wire screen panel connected to the support beam of the plurality of support beams and one of the second portions of the horizontal ammonia converter basket. In examples, the panel lateral side gap may be below a lateral ledge fixed connected to the horizontal ammonia converter basket.

In examples, the second floating connection may include one or more abutting plates each fixed connected to the support beam of the plurality of support beams and one or more lateral ledge plate extending form a lateral ledge fixed connected to the horizontal ammonia converter basket, wherein each abutting plate may be aligned with a lateral ledge plate and configured to define a respective beam lateral side gap when the support beam of the plurality of support beams may be connected to the horizontal ammonia converter basket. In examples, one or more second cover plates may be provided, each second cover plate configured to cover the respective beam lateral side gap. In examples, the respective second cover plate may be configured to overlap with at least a portion of the respective lateral ledge plate and to slide over the respective lateral ledge plate.

In examples, the second floating connection provided at a lateral end of a support beam may include two abutting plates and two lateral ledge plates, wherein the two abutting plates and the two lateral ledge plates are arranged to define two separate beam lateral side gaps. In examples, an integral cover plate may be arranged to cover both separate beam lateral side gaps and extending over both lateral ledge plates.

In examples, the second floating connection may be configured to define a first beam web lateral end gap between a vertical web portion of the support beam and a lateral ledge fixed connected to the horizontal ammonia converter basket. In examples, a third cover plate may cover the first beam web lateral gap, wherein the third cover plate may be configured to slide over the lateral ledge.

In examples, the second floating connection may be configured to define a second beam web lateral gap between a vertical web portion of the support beam and one of the second portions of the horizontal ammonia converter basket, wherein the second beam web lateral gap may be below a lateral ledge fixed connected to the horizontal ammonia converter basket.

In examples, the second floating connection may be configured to define a support beam base lateral end gap between a base portion of the support beam and one of the second portions of the horizontal ammonia converter basket.

In examples, the second floating connection may be configured to define an anti-lift bar gap between an anti-lift bar connected to a base portion of the support beam and a mating structure connected to the horizontal ammonia converter basket.

In examples, provided is a floating support grid system including a plurality of support beams, each support beam including a first lateral end and a second lateral end, opposite the first lateral end; a plurality of profile wire screen panels each connected via a respective first floating connection to at least one support beam of the plurality of support beams, each profile wire screen panel including: a first lateral side edge and a second lateral side edge; a first longitudinal side edge and a second longitudinal side edge; a grid including one or more wires; and a built-in plate over a peripheral area of the grid; one second floating connection configured to connect a first lateral side edge of a first profile wire screen panel to a horizontal ammonia converter basket; another second floating connection configured to connect a second lateral side edge of a second profile wire screen panel to the horizontal ammonia converter basket; and a third floating connection provided at each first lateral end of each support beam and at each second lateral end of each support beam, wherein the third floating connection may be configured to connect each respective first lateral end and second lateral end to the horizontal ammonia converter basket, wherein, each first floating connection may be configured to define a first gap between each profile wire screen panel and respective support beam to which it may be connected, wherein, each second floating connection may be configured to define a second gap between the respective first lateral side edge or second lateral side edge and a first or second portion of the horizontal ammonia converter basket, wherein each third floating connection may be configured to define respectively one or more third gaps between the first lateral end of each support beam and one or more third portions of the horizontal ammonia converter basket, between the second lateral end of each support beam and one of the third portions of the horizontal ammonia converter basket, between the first longitudinal side edge of each profile wire screen panel and one of the third portions of the horizontal ammonia converter basket, and between the second longitudinal side edge of each profile wire screen panel and one of the third portions of the horizontal ammonia converter basket, and wherein the first gap, the second gap, and the one or more third gaps are configured to accommodate a thermal expansion movement of one or more support beams, profile wire screen panels, or both.

In examples, provided is a horizontal ammonia converter including a horizontal ammonia converter basket; and a floating support grid system as described herein.

In examples, provided is a floating support grid system and a horizontal ammonia converter including a floating support grid having any one or more of the above features in any combination as more fully described herein.

It is to be understood that both the foregoing general description and the following detailed description are exemplary and explanatory and are intended to provide further explanation of the examples as claimed.

### BRIEF DESCRIPTION OF THE DRAWINGS

The accompanying drawings, which are included to provide a further understanding of the examples and are incorporated in and constitute a part of this specification, illustrate embodiments of the invention and together with the description serve to explain the principles of the invention.

In the drawings:

FIG. 1A illustrates a diagram of an example of a horizontal ammonia converter basket in which a floating support grid system as described may be employed.

FIG. 1B illustrates a prior art catalyst bed design.

FIG. 1C illustrates a prior art design for a profile screen wire panel.

FIG. 1D illustrates a prior art connection between a profile screen wire panel and two support beams.

FIGS. 2A-2C illustrate diagrams of examples of a floating support grid system as described herein.

FIG. 2D illustrates a diagram of an example of a profile screen wire panel that may be used in the floating support grid system described herein.

FIGS. 3A-3C illustrate front, side, and plan view diagrams of an example floating connection between one or more profile screen wire panel and a support beam that may be implemented in the floating support grid system as described herein.

FIG. 4 illustrates a diagram of an example of a floating connection between a lateral side of a profile screen wire panel and a wall or other structure of a horizontal ammonia converter basked as may be implemented in a floating support grid system described herein.

FIGS. 5A-5C illustrate diagrams of an example floating connection between a lateral end of a floating support grid system and a wall or other structure of a horizontal ammonia converter basket.

### DETAILED DESCRIPTION OF THE ILLUSTRATED EMBODIMENTS

Disclosed is a floating support grid system. In examples, the system as described provides a floating design for support grid system arrangement in a horizontal ammonia converter basket. In examples, disclosed is a floating support grid system configured to allow for one or more profile support grid wire screen panels to freely expand and contract even with rapid changes in temperature while still maintaining a catalyst containment arrangement. In examples, one or more support beams configured to support one or more profile wire screen panels may be configured to expand with temperature with little to no effect on the profile wire screen panels.

In examples, the floating support grid system may include one or more floating connections that define and/or include one or more gaps to accommodate for thermal expansion movements in the longitudinal direction and/or the lateral direction of one or more components of the floating support grid system.

In examples, the floating support grid system may include one or more support beams joined to the horizontal ammonia converter basket and/or to one or more profile wire screen panels through methods other than welding. In examples, the one or more beams may be connected to one or more profile wire screen panels via one or more floating connections. In examples, the one or more beams may be connected to the horizontal ammonia converter basket via one or more floating connections. In examples, the floating support grid system may include every connection to every support beam to include a floating connection. In examples, the floating support grid system may include some but not all connections to every support beam to define and/or include a floating connection. In examples, one or more floating connections to a support beam may define and/or include one or more gaps to accommodate for thermal expansion movement of one or more support beams, one or more profile wire screen panels, or a combination of both. In examples, every floating connection to a support beam may include one or more gaps to accommodate for thermal expansion movement of one or more support beams, one or more profile wire screen panels, or a combination of both.

In examples, the floating support grid system may include one or more profile wire screen panels joined to the horizontal ammonia converter basket and/or to one or more support beams through methods other than welding. In examples, the one or more profile wire screen panels may be connected to one or more support beams via one or more floating connections. In examples, the one or more profile wire screen panels may be connected to the horizontal ammonia converter basket via one or more floating connections. In examples, the floating support grid system may include every connection to every profile wire screen panel to include a floating connection. In examples, the floating support grid system may include some but not all connections to every profile wire screen panel to include a floating connection. In examples, one or more floating connections to a profile wire screen panel may define and/or include one or more gaps to accommodate for thermal expansion movement of one or more support beams, one or more profile wire screen panels, or a combination of both. In examples, every floating connection to a profile wire screen panel may define and/or include one or more gaps to accommodate for thermal expansion movement of one or more support beams, one or more profile wire screen panels, or a combination of both.

As used herein, the term “floating connection” refers to a connection that allows controlled movement or flexibility between the two connected components. Unlike rigid connections, which are fixed in place, a floating connection permits a certain degree of motion, such as thermal expansion, while maintaining secure attachment. A floating connection may include one or more components arranged to form a fit connection or sliding or flexible components that permit controlled movement. As used herein, floating connection excludes weld-joints or fixed connections such as those made by fasteners like screws, bolts, pins, or other like structures, and/or by welding, adhesive or like means.

In examples, the floating support grid system as described may define, include, and/or maintain one or more separation gaps for the support beams and/or for the profile wire screen panels to allow for differential expansion between the beams and the profile wire screen panels. In examples, one or more gaps between the beams and the profile wire screen panels may be provided to allow for differential expansion movement between the beam and the profile wire screen panels. In examples, one or more gaps the beams and the walls or other portion of the horizontal ammonia converter basket may be provided to allow for expansion movement of the beams. In examples, one or more gaps may be provided between a profile wire screen panel and the walls or other portion of the horizontal ammonia converter basket to allow for expansion movement of the profile wire screen panel.

In examples, the gaps may be covered by cover plates to prevent catalyst or other debris from entering the gaps and causing migration of catalyst. In examples, individual profile wire screen panels may be protected on the sides with built-in plates to avoid or minimize rubbing and thus shear stress between cover plate and the wires of the profile wire screen panel. In examples, the floating support grid system as described may include one or more anti-lift mechanisms. In examples, one or more anti-lift mechanisms may be provided to prevent lifting of one or more profile wire screen panels. In examples, one or more anti-lift mechanisms may be provided to prevent lifting of one or more support beams.

In examples, the horizontal ammonia converter basket equipped with a floating support grid system as described may be able to withstand higher rates of temperature changes typically seen in uncontrolled upset conditions. This may help safeguard the equipment and prevent failures and/or loss of catalyst containment functionality. For purposes of this disclosure “catalyst containment” as referring to the functionality of the floating support grid system refers to the catalyst substantially remaining on the floating support grid system as opposed to falling through in an unintended manner.

Reference will now be made in detail to one or more examples, which are illustrated in the accompanying drawings.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

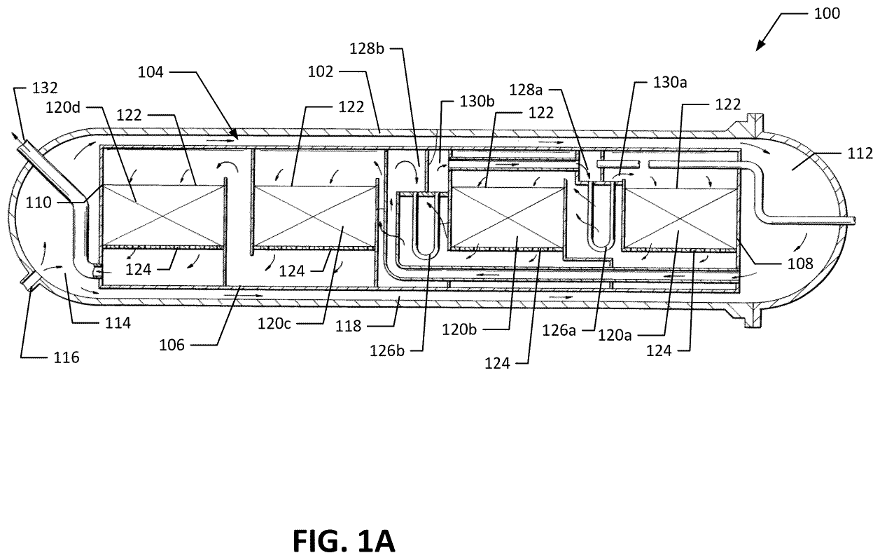

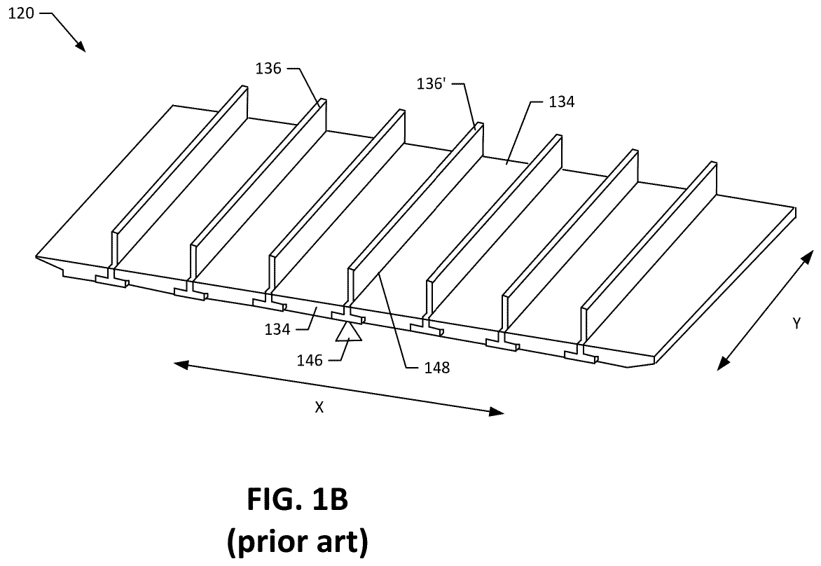

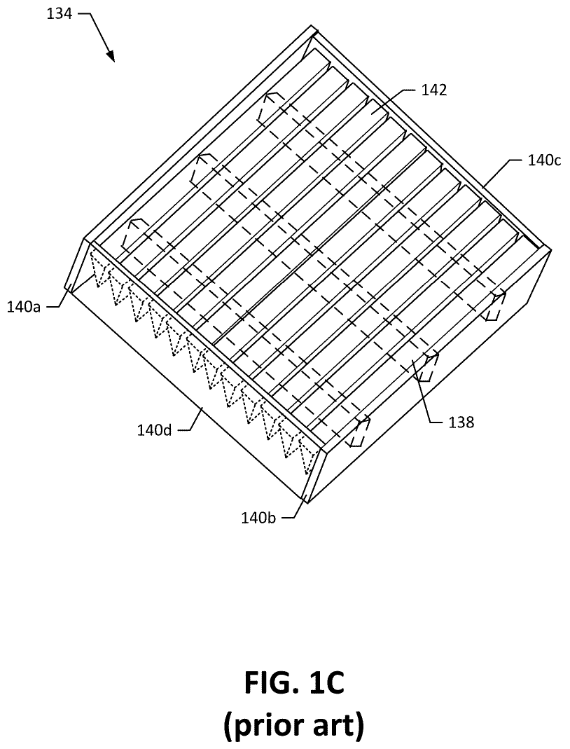

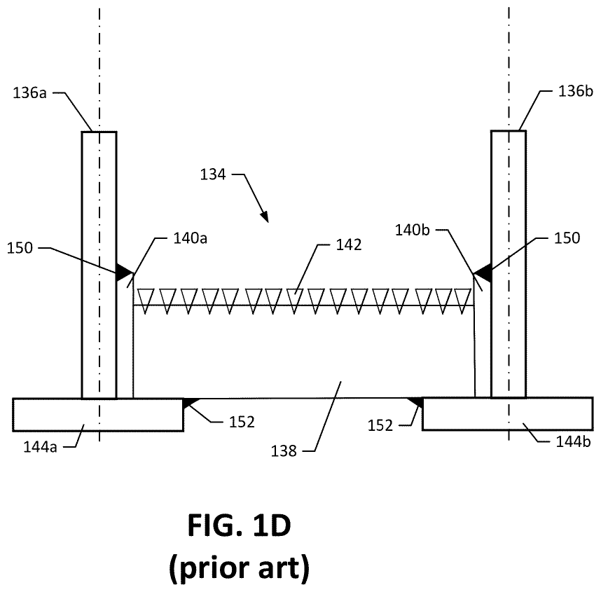

FIG. 1A provides a diagram of an example of a horizontal ammonia converter basket 104 in which the floating support grid system as described herein may be employed. The illustration is only an example. The floating support grid system as described herein may be employed in other horizontal ammonia converter basket designs. Non-limiting examples of horizontal ammonia converter basket designs in which the floating support grid system as described herein may be employed are described in U.S. Pat. Nos. 4,696,799, 7,867,465, and 6,132,687, all of which are incorporated herein by reference in their entirety.

In examples, horizontal ammonia converter 100 may generally include a vessel 102 and a horizontal ammonia converter basket 104 inside vessel 102. In examples, a horizontal ammonia converter basket 104 may include a cylindrical inner portion 106 disposed within vessel 102, a first end closure 108 and a second end closure 110. In examples, first end closure 108 and second end closure 110 may be attached to ends of vessel 102 and form first gas plenum 112, and second gas plenum 114, respectively. A gas inlet 116, may be provided to feed relatively cool ammonia synthesis gas into the second gas plenum 114, a shell annulus 118, and then to the first gas plenum 112.

One or more catalyst beds 120 (e.g. 120a, 120b, 120c, and 120d) may be provided inside a horizontal ammonia converter basket 104 vessel. Each catalyst bed 120 may include a top inlet portion 122 and a bottom outlet portion 124, the catalyst particles being supported by grids and screens not shown. In examples, the catalyst beds 120 may be arranged for downward flow of gas in a path substantially normal to the axis of vessel 102 of the horizontal ammonia converter basket 104.

In examples, the horizontal ammonia converter basket 104 may further include one or more tubular heat exchangers 126 (e.g., 126a and 126b) having respective tube inlet portions 128 (e.g., 128a and 128b) and tube outlet portions 130 (e.g., 130a and 130b) located between catalyst beds 120. In examples, a first tubular heat exchanger 126a may include a vertical U-tubes to provide high internal tube gas velocity and, therefore, high heat transfer rates which thereby minimize the size of this exchanger.

In examples, the horizontal ammonia converter basket 104 may include a flow path through the catalyst beds 120 and first and second exchangers provided by longitudinal conduits within the cylindrical inner portion 106 above and below the catalyst beds 120.

As illustrated, gas may be introduced to flow across tube interior of the tubular heat exchangers 126 and then flows upwardly through a channel and into top inlet portion 122 of a first catalyst bed 122a. The gas then may be channeled as illustrated to flow to one or more subsequent catalysts beds 122 (e.g., 122b, 122c, and 122d) in a similar manner by flowing into the respective top inlet portion 122 and out the bottom outlet portion 124 of each catalyst bed 122. Ultimately, the gas may be output from the horizontal ammonia converter basket 104 via an outlet pipe 132.

FIGS. 1B-1D illustrate prior art arrangements of support grid or screen for catalyst beds 120. FIG. 1B is a diagram of a perspective view. As shown, a catalyst bed 120 may include one or more profile wire screen panels 134 and one or more support beams 136. In known arrangements, the profile wire screen panels 134 are welded to the support beams 136. As shown, the weld-joint may be formed along each abutting edge 148 of profile wire screen panels 134. FIG. 1D illustrates a side view of a single profile wire screen panel 134 welded to two abutting supporting beams 136 (e.g. 136a and 136b).

As illustrated in FIG. 1C, a profile wire screen panel 134 may include a grid of V wires 142. In examples, a profile wire screen panel 134 may generally include one or more panel support bars 138 located under and configured to support the grid of wires 142. As shown, a profile wire screen panel 134 may include an edging bar 140 at each side (e.g. 140a, 140b, 140c, and 140d). In examples, the wires 142 are at the top inlet portion 122 of the catalyst bed and are configured to hold the catalyst while allowing the gas to pass through.

As shown in FIG. 1D, in known arrangements, the profile wire screen panels 134 rest on at least a portion of a base 144 (e.g. 144a and 144b) of the support beams 136a and 136b respectively and are connected to the support beams 136 along each abutting edge 148 by one or more welded joints 150 connecting the edging bars 140 to the support beams 136, and/or by one or more welded joints 152 connecting at least one panel support bar 138 to the base 144 of support beams 136.

The welded joints between the profile wire screen panels 134 and the support beams 136 lead to an overall integral structure.

As shown in FIG. 1B, the integral structure including the profile wire screen panels 134 and the support beams 136 is generally fixed at 146 to the cylindrical inner portion 106 of the horizontal ammonia converter basket 104 by only a single support beam, and particularly by the central support beam 136′.

With this arrangement, the catalyst bed 120 can risk structural failure or break of catalyst containment. This is because during operation the heat in vessel 102 may cause the profile wire screen panels and/or one or the beams to expand. This thermal expansion gives rise to a motion in the longitudinal direction X, traverse Y direction, or both of the catalyst bed 120. Being an integral structure, this expansion motion of a profile wire screen panel 134 can induce sliding motion of a support beam 136 along the longitudinal X direction on the whole catalyst bed 120. In case of mal-operational or sever plan upsets, the support grid system may be subjected to rapid changes in temperature (beyond permissible range). In such a scenario, the support beams are required to expand and move within the catalyst bed. Such expansions and movements may be resisted by the catalyst leading to resistance and excessive stresses in the support grid system consequently leading to failure of the support grid system, which can lead to structural failure or break of catalyst containment.

To resolve this issue in the prior art systems, the present disclosure provides a floating support grid system in which the profile wire screen panels are not welded to the support beams. In examples, in the floating support grid system as described, all the support beams may be connected to the horizontal ammonia converter basket.

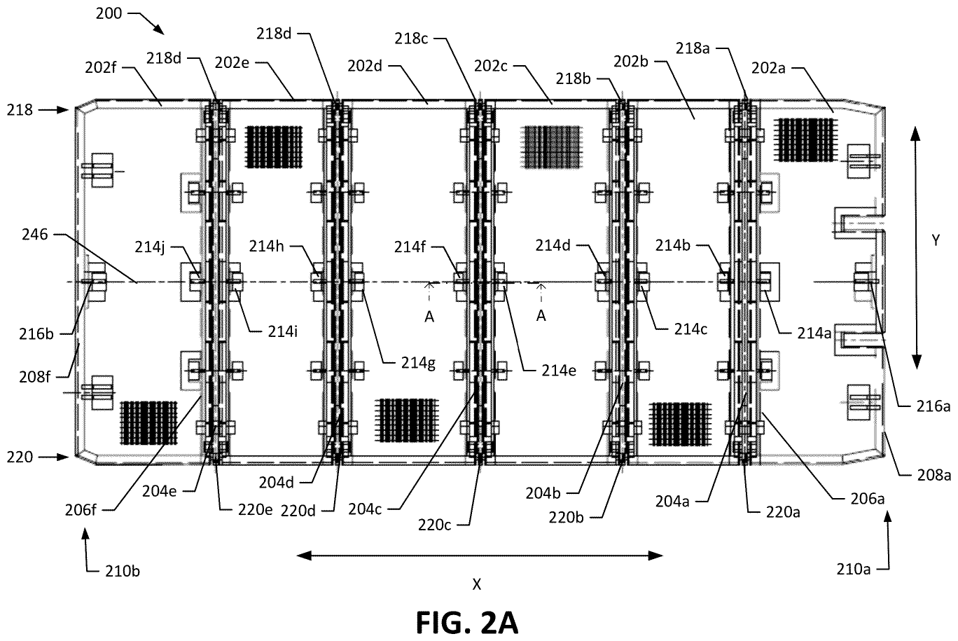

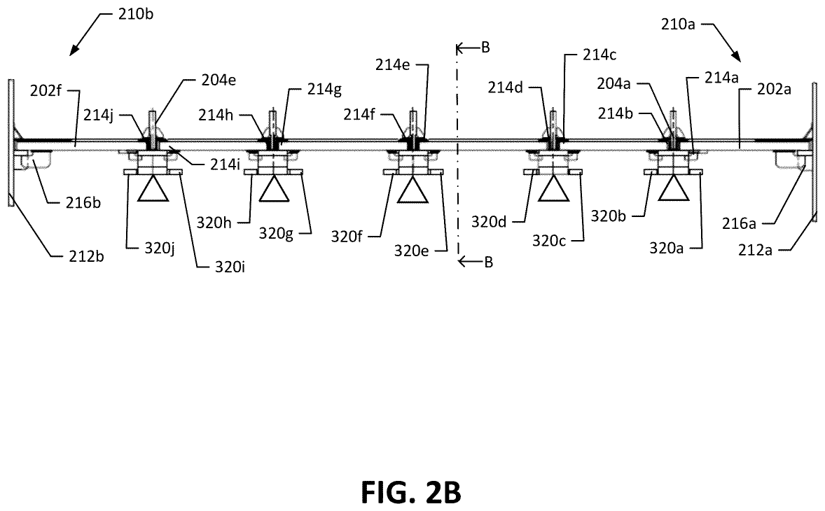

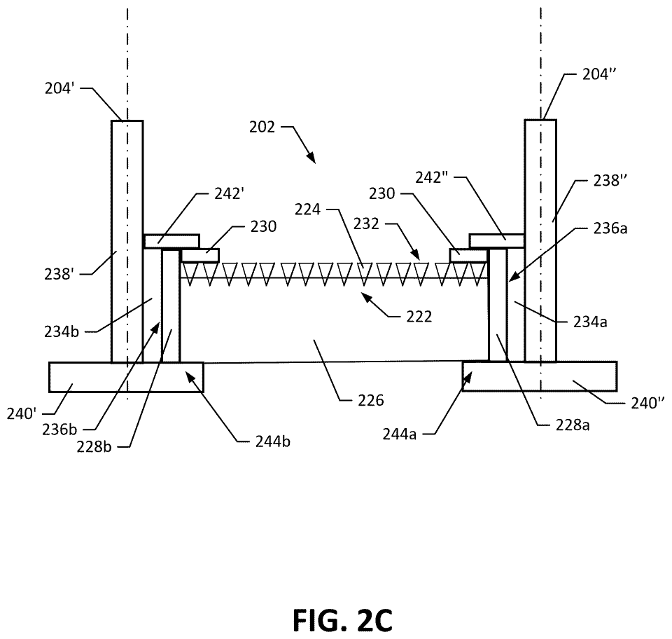

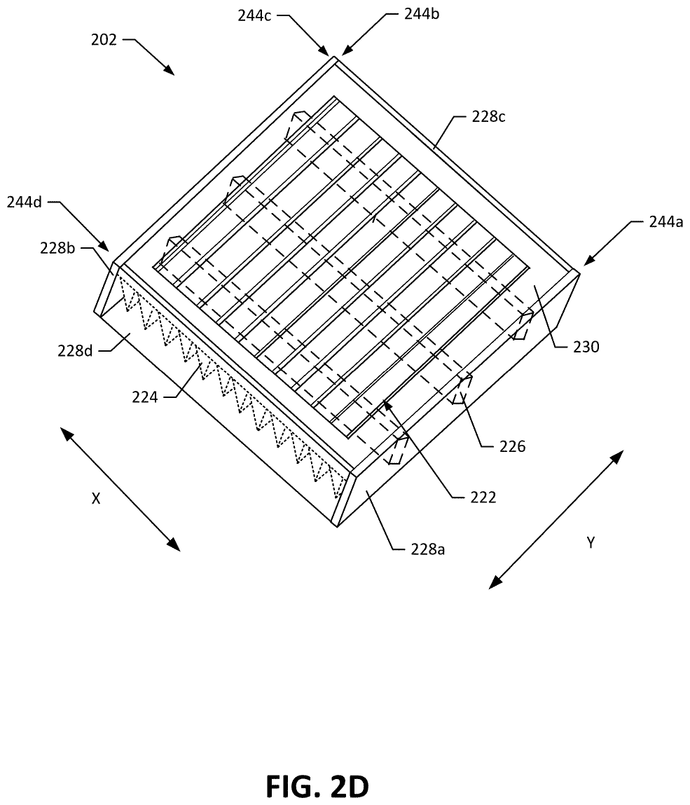

FIGS. 2A-2C illustrate diagrams of an example of a floating support grid system as described herein in which the profile wire screen panels are not welded to the support beams.

FIG. 2A illustrates a plan view of an example of a catalyst bed support implemented by way of a floating support grid system 200 as described herein. In examples, the floating support grid system 200 may include a plurality of profile wire screen panels 202. In examples, the floating support grid system 200 may include one or more profile wire screen panels 202 (e.g., 202a, 202b, 202c, 202d, 202c, and 202f). In examples, the floating support grid system 200 may include a plurality of support beams 204. In examples, the floating support grid system 200 may include one or more support beams 204 (e.g., 204a, 204b, 204c, 204d, and 204c). In examples, a floating support grid system 200 may be implemented to include any number of profile wire screen panels 202 and/or support beams 204. In examples, the number of profile wire screen panels 202 in a floating support grid system 200 may depend on the overall size of the floating support grid system 200, the size of the profile wire screen panels 202, the number and/or size of support beams 204, and/or the size of the space in which the floating support grid system 200 is to be installed. In examples, the number of support beams 204 in a floating support grid system 200 may vary depending on their size, the number and/or size of the profile wire screen panels 202, the size and structural strength of the support beams 204, the overall size of the a floating support grid system 200, and/or the size of the space in which the a floating support grid system 200 is to be installed. For purposes of illustration, as an example, FIG. 2A illustrates a floating support grid system 200 with six profile wire screen panels 202 and five support beams 204.

In examples, each profile wire screen panel 202 may be supported by one or more support beams 204. In examples, the floating support grid system 200 may include one or more profile wire screen panels 202 supported by at least two support beams 204. For example, as shown in FIG. 2A, profile wire screen panels 202b, 202c, 202d, and 202e are each supported by two abutting support beams 204. As shown in FIG. 2B, in examples, the floating support grid system 200 may include one or more profile wire screen panels 202 supported by combination of a support beam 204 and one or more portions 212, e.g. 212a and 212b, of a horizontal ammonia converter basket, e.g., a wall or other internal structure, of horizontal ammonia converter basket. For example, such profile wire screen panels 202 may be those located at a longitudinal (i.e. in the longitudinal X direction) end portion 210, e.g. 210a and 210b, of the floating support grid system 200. As illustrated in FIG. 2B, these may include profile wire screen panels 202a and 202f, wherein each is respectively supported by support beam 204a and 204c on a respective inner edge side, e.g. 206a and 206f, while each having a respective outer edge side, e.g. 208a and 208f, designated to be connected to respective portions 212a and 212b of horizontal ammonia converter basket such as a wall or inner structure thereof. In examples, at longitudinal end portions 210a and 210b a floating support grid system 200 may include one or more third floating connections, referred to herein as longitudinal end connections 216 (e.g., 216a and 216b) configured to directly connect profile wire screen panels 202 to the horizontal ammonia converter basket system. In examples, a longitudinal end connection 216 may include floating connection. In examples, every longitudinal end connection 216 of floating support grid system 200 may include a floating connection. In examples, a longitudinal end connection 216 may include a floating connection that is also an anti-lift connection. In examples, every longitudinal end connection 216 of floating support grid system 200 may include a floating connection that is also an anti-lift connection.

In examples, one or more of support beams 204 of floating support grid system 200 may be configured to be connected to the horizontal ammonia converter basket. In examples, each and every support beam 204 may be configured to be connected to the horizontal ammonia converter basket. This may be in contrast to the prior art system in which only a central support beam is fixed to the horizontal ammonia converter basket system. In examples, one or more connections between each support beam 204 and the horizontal ammonia convert basket may include a floating connection.

In examples, a support beam 204 may be connected to a horizontal ammonia converter basket at one or both lateral (i.e. width direction Y) end portions 218 (e.g., 218a, 218b, 218c, and 218d) and 220 (e.g., 220a, 220b, 220c, and 220d). For example, support beam 204c, may be connected to a horizontal ammonia converter basket at lateral end portions 218c and 220c. In examples, each connection between a support beam 204 and the horizontal ammonia converter basket system at lateral end portions 218 and 220 may be a floating connection. In examples, as described herein, every support beam 204 of floating support grid system 200 may be connected at both respective lateral end portions 218 and 220 to the horizonal ammonia converter basket. In examples, every connection at each lateral end portion 218 and 220 of every support beam 204 may include a floating connection.

In examples, none of the profile wire screen panels 202 are welded to any of the support beams 204. In examples, the floating support grid system 200 may include one or more first connections, or a plurality of first connections each connecting a support beam 204 to a profile wire screen panel 202. In examples, each first connection, referred to herein as beam-panel connection 214 (e.g., 214a, 214b, 214c, 214d, 214c, 214f, 214g, 214h, 214i, and 214j) between a profile wire screen panel 202 and a support beam 204 may include a floating connection. In examples, a beam-panel connection 214 may include a floating connection that is also an anti-lift connection. In examples, every beam-panel connection 214 of floating support grid system 200 may include a floating connection that is also an anti-lift connection. In examples, a beam-panel connection 214 may be provided to connect a lateral side (i.e. along the width or Y direction) of a support beam 204 to a lateral side edge 244a or 244b of a profile wire screen panel 202. In examples, a beam-panel connection 214 between a support beam 204 and a profile wire screen panel 202 may be provided at or along a midsection and/or central portion of support beam 204, a profile wire screen panel 202 or grid 222, or a combination thereof.

As used herein, the term “midsection” when referring to the floating support grid system 200 as a whole, to a support beam 204, to a profile wire screen panel 202, and/or to a grid 222 or wires 224, indicates an area that is not at a lateral (i.e. in the width or Y direction) peripheral edge of the structure. As used herein, the term “central portion” or “center” when referring to the floating support grid system 200 as a whole, to a support beam 204, to a profile wire screen panel 202, and/or to a grid 222 or wires 224, indicates an area along line 246 that corresponds to the middle or approximately the middle of the width (i.e. dimension in the width or Y direction) of the referred structure.

In examples, a longitudinal end connection 216 between a profile wire screen panel 202 and a portion 212 of a horizontal ammonia converter basket may be provided at or along a midsection and/or central portion of a lateral side edge end of the profile wire screen panel 202. In examples, a longitudinal end connection 216 may be aligned with at least one beam-panel connection 214 for that same profile wire screen panel 202. In examples, a floating support grid system 200 may be configured such that every beam-panel connection 214 between each profile wire screen panel 202 and respective support beam 204, and every longitudinal end connection 216 between a profile wire screen panel 202 and a portion 212 of a horizontal ammonia converter basket are aligned.

In examples, the floating support grid system 200 can exhibit sufficient structural integrity to support the catalyst and operate as intended in a horizontal ammonia converter basket, while also being configured to allow for thermal expansion movements of one or more profile wire screen panels 202 and/or support beams 204. In examples, this may result in reduced, or no stress imposed on the overall floating support grid system 200 in the longitudinal direction X, especially when compared to a catalyst bed in which the profile wire screen panels are welded joint to the beams as previously described with reference to FIGS. 1A-1C. In examples, the floating support grid system 200 may also be configured to exhibit reduced or no stress imposed on the overall floating support grid system 200 in the width direction Y. In examples, the floating support grid system 200 may also be configured to exhibit reduced or no stress imposed on the overall floating support grid system 200 in the width direction Y and in the length or longitudinal direction X.

FIGS. 2C and 2D illustrate a diagram illustrating a side view of an example of a profile wire screen panel 202 supported by two support beams 204 (e.g., 204′ and 204″) as implemented in a floating support grid system 200 and of an example profile wire screen panel 202 as employed in a floating support grid system 200.

In examples, as shown in FIG. 2D, a profile wire screen panel 202 may include a grid 222 of one or more wires 224. In examples, the wires 224 may include wedge wires, i.e. wires with a triangular and/or wedge-shaped cross-section. In examples, a profile wire screen panel 202 may include one or more support bars 226. In examples, support bars 226 may be provided under one or more wires 224, i.e. on the side of one or more wires 224 that is opposite the side of where a catalyst is held during use of the profile wire screen panel 202 when installed in a horizontal ammonia converter basket. In examples, a support bar 226 may be connected to one or more wires 224 and/or grid 222. In examples, a support bar 226 may be arranged to have its longitudinal (i.e. X direction) side perpendicular to or substantially perpendicular to the lateral (i.e. Y direction) side of one or more wires 224. In examples, the profile wire screen panel 202 may include one or more edge bars 228 (e.g., 228a, 228b, 228c, and 228d). In examples, an edge bar may extend along the full length of at least one side of grid 222. In examples, an edge bar 228 (e.g., 228a and 228b) may be arranged to have its lateral (i.e. Y direction) side parallel or substantially parallel to one or more wires 224. In examples, an edge bar 228 (e.g., 228c and 228d) may be arranged to have its longitudinal (i.e. X direction) side perpendicular or substantially perpendicular to one or more wires 224. In examples, an edge bar 228 may be connected to the one or more support bars 226. In examples, two edge bars 228 may be connected to one another. In examples, an edge bar 228 may be connected to one or more wires 224. In examples, the connection between one or more support bars 226 and one or more wires 224, grid 222, and/or edge bar 228 may be a welded joint. In examples, the connection between one or more edge bars 228 and one or more wires 224, grid 222, and/or other edge bar 228 may be a welded joint.

In examples, a profile wire screen panel 202 as implemented in a floating support grid system 200 described herein may include one or more built-in plates 230. In examples, as shown, a built-in plate 230 may be located at a peripheral area of a top surface 232 of grid 222 and/or one or more wires 224. In examples, as shown, a built-in plate 230 may be located only at a peripheral area of grid 222 and/or one or more wires 224. As used herein, a “peripheral area” refers to an outer portion of a surface that surrounds a central portion of the surface. In examples, a built-in plate 230 may extend around the full perimeter of a top surface 232 of the grid 222 over one or more wires 224 (i.e. directly opposite side of wires 224 from where the one or more support bars 226 are located) of profile wire screen panel 202. In examples, built-in plate 230 may extend only a portion of the perimeter. In examples, built-in plate 230 may include a single integral plate extending the full perimeter of top surface 232. In examples, built-in plate 230 may include a set of two or more plates. In examples, a built-in plate 230 may extend over top surface 232 of grid 222 and/or one or more wires 224 from about 12 mm (or 0.5 inch) to about 75 mm (or 3 inch) as measured from a side edge of the grid 222 and/or one or more wires 224 toward the middle of grid 222 and/or one or more wires 224 for.

The profile wire screen panel 202 may include a metal or metal alloy. In examples, the one or more wires 224 of grid 222, the one or more support bars 226, the one or more edge bars 228, and the built-in plate 230 may each independently include a metal or metal alloy material. In examples, the one or more wires 224 of grid 222, the one or more support bars 226, the one or more edge bars 228, and the built-in plate 230 may all include the same material. In examples, the one or more wires 224 of grid 222, the one or more support bars 226, the one or more edge bars 228, and the built-in plate 230 may each independently include the same or different material of any other portion of profile wire screen panel 202. In examples, the one or more wires 224 of grid 222, the one or more support bars 226, the one or more edge bars 228, and the built-in plate 230 may each independently include steel or other metal alloy.

In examples, as illustrated in FIG. 2C, in floating support grid system 200, a profile wire screen panel 202 may be connected to two support beams 204 by a floating connection that defines and/or includes an edge gap 234 between at least a portion of a lateral (i.e. along the width or Y direction) side edge 244a or 244b of profile wire screen panel 202 and a portion of the support beam 204 that is configured to support that lateral side edge 244a or 244b of profile wire screen panel 202. In examples, edge gap 234 may extend between the profile wire screen panel 202 and the support beam 204 connected thereto along the full length of lateral side edge 244a or 244b of profile wire screen panel 202. In examples, where a profile wire screen panel 202 is between two support beams 204 as shown in FIG. 2C, an edge gap 234 may be present either between either lateral side edge 244a or 244b of profile wire screen panel 202 and respective support beam 204 (e.g., 204′ and 204″) that supports that side edge. In examples, where a profile wire screen panel 202 is between two support beams 204 as shown in FIG. 2C, two edge gaps 234 (e.g. 234a and 234b) may be present, one between each lateral side edge 244a and 244b of profile wire screen panel 202 and respective support beam 204 (e.g., 204′ and 204″) that supports that side edge. In examples, where profile wire screen panel 202 includes an edge bar 228 as illustrated in FIGS. 2C and 2D, then edge gap 234 may be present between at least a portion of the edge plate 228 and support beam 204. In examples, edge gap 234 may have a width A, i.e. shortest distance from a surface of support beam 204 to a surface at a lateral side edge 244a or 244b of profile wire screen panel 202 and/or of edge bar 228 if present. In examples, an edge gap 234 may range from about 3 mm (or ⅛ inch) to about 25 mm (or 1 inch). In examples, the edge gap 234 is provided between an outer surface 236 (e.g., 236a and 236b) of edge plate 228 and a vertical portion of beam 204. In examples, the outer surface 236 of edge plate 228 is the surface that faces away from grid 222 of wires 224.

In examples, a support beam 204 may include at least a portion forming an inverted T-shaped profile with a vertical web portion 238 (e.g., 238′ and 238″) extending upward from a top surface of a bottom horizontal base portion 240 (e.g., 240′ and 240″). In examples, edge gap 234 is located between a lateral side edge 244a or 244b of a profile wire screen panel 202 and a surface of vertical web portion 238 of a support beam 204. In examples, where a profile wire screen panel 202 includes an edge bar 228, the edge gap 234 may be located between outer surface 236 of an edge bar 228 and a surface of vertical web portion 238 of support beam 204. In examples, as profile wire screen panel 202 moves laterally (i.e. in the longitudinal direction X) due to thermal expansion, edge gap 234 may accommodate the expansion thus avoiding structural impingement and thus stress to one or more components of the floating catalyst support system 200.

In examples, as also shown in FIG. 2C, the floating catalyst support system 200 may include one or more cover plates 242. In examples, a cover plate 242 may be arranged and configured to prevent or impede debris or catalyst that is loaded over a profile wire screen panel 202 from reaching and/or entering edge gap 234. In examples, a cover plate 242 may extend from a support beam 204. In examples, a cover plate 242 may be welded, mechanically fastened by bolts or like structures, or both to a support beam 204. In examples, a cover plate 242 may be provided on one or both sides of vertical web portion 238 of a support beam 204. In examples, as shown in FIG. 2C, each support beam 204′ and 204″ may include one or more cover plates 242 (e.g., 242′ and 242″) where a profile wire screen panel 202 is to be installed. In examples, a cover plate 242 may be arranged and configured to at least partially overlap the built-in plate 230 of a profile wire screen panel 202 when the profile wire screen panel 202 is connected to a support beam 204 in a floating catalyst support system 200. In examples, a cover plate 242 may be arranged and configured to at least partially overlap the edge plate 228 of a profile wire screen panel 202 when the profile wire screen panel 202 is connected to a support beam 204 in a floating catalyst support system 200. In examples, a cover plate 242 may be arranged and configured to overlap the edge plate 228 and at least partially overlap built-in plate 230 of a profile wire screen panel 202 when the profile wire screen panel 202 is connected to a support beam 204 in a floating catalyst support system 200. In examples, the overlap between a cover plate 242 and built-in plate 230 may be of about 12 mm (or 0.5 inch) to 50 mm (or 2 inch).

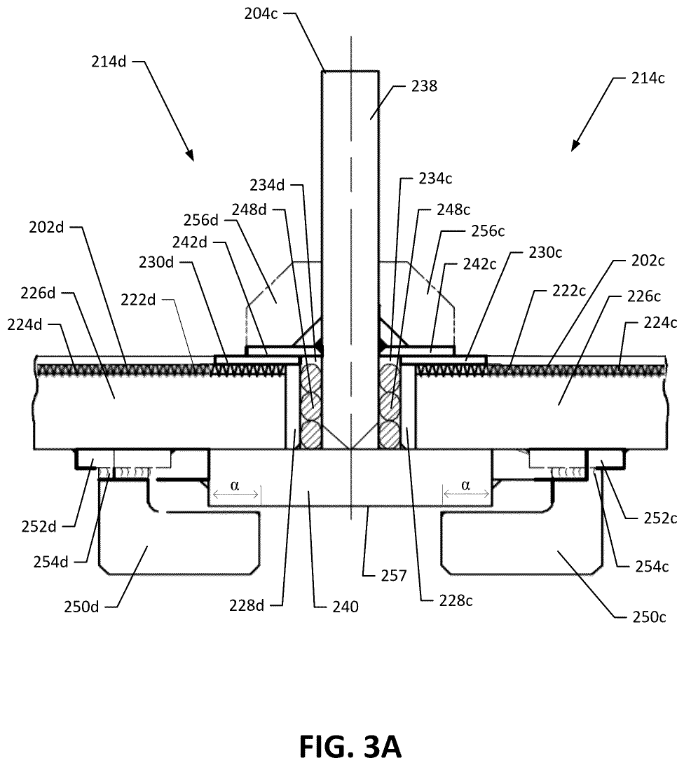

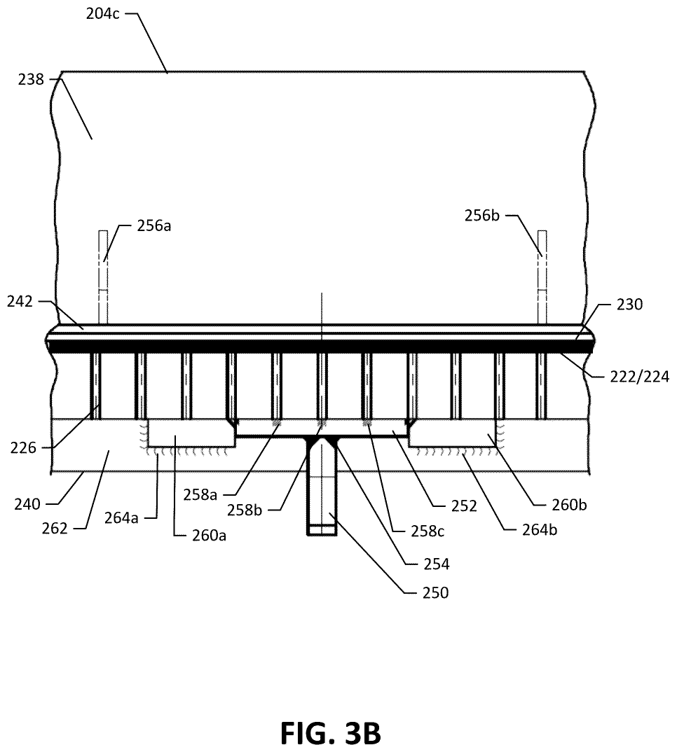

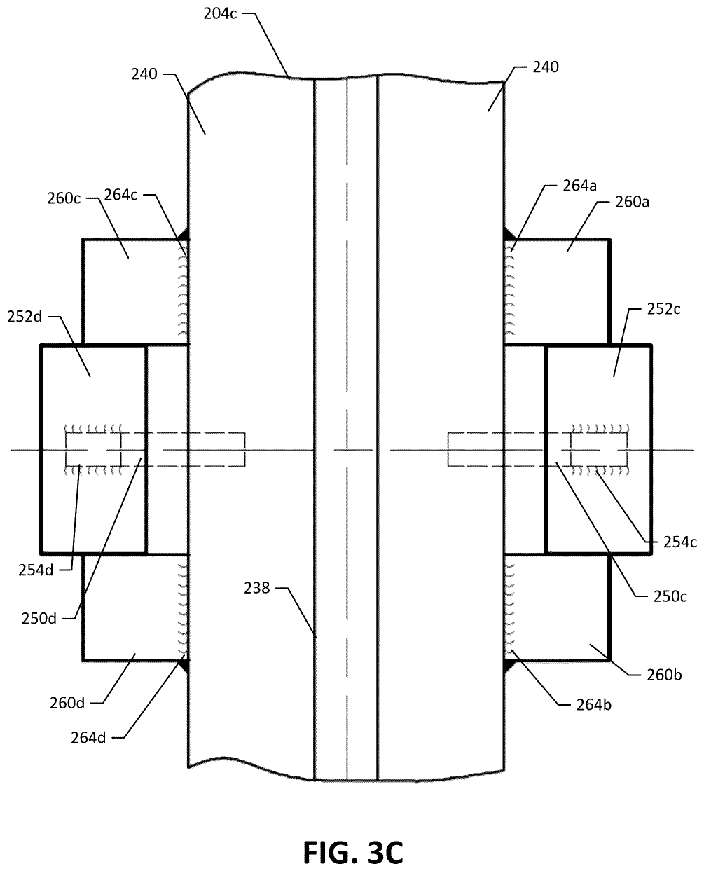

An example beam-panel connection 214 that may be employed in the floating support grid system 200 is illustrated in FIGS. 3A-3C. FIG. 3A illustrates cross-section view of beam-panel connections 214e and 214f taken at A-A in FIG. 2A. Beam-panel connections 214e and 214f are only used for illustrative purposes. All beam-panel connections 214 may be implemented as illustrated. FIGS. 3B and 3C respectively illustrate a cross-section side view proximate to beam-panel connection 214e of floating support grid system 200 taken from B-B in FIG. 2B, and a plan view a beam-panel connections 214e and 214f.

In examples, as shown in FIG. 3A, a first and second profile wire screen panel 202, for example 202c and 202d, provided on both sides of a support beam 204, e.g. 204c. As described earlier, each profile grid panel 202 may include a respective grid 222 (e.g. 222c and 222d) of wires 224 (e.g. 224c and 224d), respective one or more a support bars 226 (e.g. 226c and 226d), respective an edge bar 228 (e.g. 228c and 228d), and a respective built-in plate 230 (e.g., 230c and 230d). Support beam 204c may include an inverse T-shape profile including a vertical web portion 238 extending upward from a horizontal base portion 240. As illustrated, the profile wire screen panels 202 may be supported at least at one edge portion by the support beam horizontal base portion 240 on either side of vertical web portion 238. As also shown, an edge gap 234 (e.g. 234c and 234d) is formed between each profile wire screen panel 202 and the support beam 204. In examples, ceramic rope 248 (e.g. 248c and 248d) may be provided in edge gap 234 between a profile wire screen panel 202 and a support beam 204. In examples, ceramic rope 248 may include any suitable ceramic rope material. In examples, ceramic rope 248 can easily compressed. In examples, ceramic rope 248 may include fiberglass. In examples, ceramic rope 248 can help prevent catalyst and/or other debris from entering edge gap 234.

In examples, as shown in FIG. 3A and as previously described, floating support grid system 200 may include one or more cover plates 242 extending from one or more support beams 204. In examples, shown in FIG. 3A, respective cover plates 242c and 242d may be provided to extend over at least an edge portion of respective profile wire screen panels 202c and 202d. As previously described, a cover plate 242 may be configured to extend over at least a portion of built-in plate 230. In examples, cover plate 242 overlaps built-in plate 230. In examples, not binding connection is present between cover plate 242 and built-in plate 230. In this manner, in examples, a profile wire screen panel 202 may undergo thermal expansion and/or contraction by moving, e.g., by sliding, between cover plate 242 and base portion 240 of beam 204. In examples, the built-in plate 230 of a profile wire screen panel 202 has a width sufficiently sized to cover the maximum about of movement a profile wire screen panel 202 may experience. In examples, built-in plate 230 may protect grid 222 and/or wires 224 of profile wire screen 202 by preventing rubbing of cover plate 242 on grid 222 and/or wires 224 during movement caused by thermal expansion or restriction.

In examples, cover plate 242 may be provided to prevent catalyst loaded over the top surface of a profile wire screen 202 from reaching edge gap 234. In examples, a floating support grid system 200 may be configured so that a gap between cover plate 242 and built-in plate 230 is less than a particle diameter of a catalyst to be loading on profile wire screen panel 202 during operation of the horizontal ammonia converter basket. In examples, a cover plate 242 may be positioned such that when profile wire screen panel 202 is connected to support beam 204 via the floating connection, a gap between cover plate 242 and built-in plate 230 prevents or impedes catalyst particles or debris from reaching edge gap 234.

In examples, to ensure the gap between cover plate 242 and a built-in plate 230 is maintained substantially uniform and/or within a desired range, floating support grid system 200 may include one or more cleats 256. In examples, a cleat 256 may be configured to extend from a side of vertical web portion 238 of a support beam 204 to a top surface of cover plate 242, wherein the top surface of cover plate 242 is opposite the surface facing base portion 240 of support beam 204. In examples, cleat 256 may include a wedge-shaped piece, however, it may include any desired shape. In examples, a cleat 256 may be made of the same or different material as support beam 204. In examples, a cleat 256 may include a metal or metal alloy, for example steel. In examples, a support beam 204 may include one or more cleats 256 along width Y of floating support grid system 200.

As illustrated in FIG. 3A, a support beam 204, e.g. 204c, may include one or more cleats 256, e.g. 256c and 256d, one either or both side of vertical web portion 238. In examples, one or more cleats 256 may be provided whenever a cover plate 242 is present. In examples, one or more cleats 256 may be provided at one or more locations along a lateral side of vertical web portion 238. In examples, when more than one cleat 256 is present, they may be regularly spaced or irregularly spaced along the full lateral length of vertical web portion 238 and/or cover plate 242.

In examples, a profile wire screen panel 202 may include an anti-lift system including an anti-lift bar 250. In examples, anti-lift bar 250 may be provided at a bottom portion of a profile wire screen panel 202. In examples, anti-lift bar 250 may be connected to one or more support bars 226 of a profile wire screen panel 202. In examples, an anti-lift bar 250 may be connected to a bottom surface of one or more support bars 226 that is opposite the surface of the one or more support bars 226 facing and/or connected to grid 222 and/or wires 224. In examples, anti-lift bar 250 may be connected directly to one or more support bars 226. In examples, the connection between anti-lift bar 250 and one or more support bars 226 may be a welded joint. In examples, one or more connecting plates 252 may be placed between an anti-lift bar 250 and one or more support bars 226. In examples, the anti-lift system may include a connecting plate 252. In examples, a connecting plate 252 may be connected to two or more support bars 226 on a first side and to one or more anti-lift bars 250 on a second side opposite the first side. In examples, connecting plate 252 may have a profile that extends across an area that reaches two or more support bars 226. In this manner connecting plate 252 may be more easily connected to two or more support bars 226. In examples, at least one anti-lift bar 250 may be connected to connecting plate 252. In examples, all connections between anti-lift bar 250 and either a support bar 226 or a connecting plate 252 may be fixed connections such as welded joints 254 and/or a mechanical fastened joint such as by screw and bolt or other like structure, or any combination thereof. Similarly, in examples. all connections between a support bar 226 and a connecting plate 252 may be fixed connections such as welded joints and/or a mechanical fastened joint such as by screw and bolt or other like structure, or any combination thereof. In examples, anti-lift bar 250 and connecting plate 252 may include the same or different materials used for one or more of the other components of profile wire screen panel 202. In examples, anti-lift bar 250 and connecting plate 252 may each independently include a metal or metal alloy, for example steel.

In examples, as illustrated in FIG. 3A, each of profile wire screen plates 202c and 202d may include an anti-lift bar 250 (e.g., 250c and 250d). In examples, each of anti-lift bars 250c and 250d may be connected to a respective connecting plate 252c and 252d via a respective fixed connection such as weld joins 254c and 254d. In examples, each connecting plate 252c and 252d may be connected to one or more respective support bars 226c and 226d. In examples, although not shown, connecting plates 252c and 252d are connected to respective one or more support bars 226c and 226d by a fixed connection such as a welded joint or bolt and screw type of fastening joint or a combination thereof.

In examples, as shown in FIG. 3A, an anti-lift bar 250 may be configured to extend to reach below a bottom surface 257 of base portion 240 of a support beam 204. In examples, anti-lift bar 250 may extend at least a distance a over bottom surface 257 of base portion 240. In examples, distance a may range from about 25 mm (or 1 inch) to about 50 mm (or 2 inch). In examples, an anti-lift bar 250 may assist in preventing or hindering the lifting or vertical displacement of a profile wire screen panel 202.

FIG. 3B illustrates a cross-section side view to beam-panel connection 214c of floating support grid system 200 taken from B-B in FIG. 2B. FIG. 3B shows a vertical web portion 238 of support beam 204c, with two cleats 256 (e.g. 256a and 256b) extending diagonally from vertical web portion 238 to a cover plate 242. As shown, cover plate 242 abuts but is not connected to built-in plate 230 of a profile wire screen panel 202, e.g. 202c. Below built-in plate 230, profile wire screen panel 202 includes grid 222 of wires 224. Below grid 222, profile wire screen panel 202 includes one or more support bars 226. As illustrated, when profile wire screen panel 202 is connected to support beam 204, at least an edge portion of profile wire screen panel 202 may rest of a base portion 240 of the inverted T-shaped support beam 204. As illustrated, profile wire screen panel 202 may include a connection plate 252 fixed joined, e.g. welded, to one or more support bars 226, for example at weld locations 258 (e.g. 258a, 258b, 258c). In examples, an anti-lift bar 250 may be fixed joined to connection plate 252. In examples, the fixed joint 254 between anti-lift bar 250 and connection plate 252 may be one or more welded joints. As illustrated, anti-lift bar 250 may reach under base portion 240 of support beam 204.

In examples, as shown in FIG. 3B, floating support grid system 200 may include a beam-panel connection 214 with one or more stoppers 260 (e.g. 260a and 260b) to prevent movement of a profile wire screen panel 202 in a lateral or Y direction of the floating support grid system 200. In examples, a stopper 260 may include any suitable material. In examples, a stopper 260 may include the same or different material as support beam 204. In examples, stopper 260 may include a metal or metal alloy, for example steel. In examples, a stopper 260 may be joined to base portion 240 of a support beam 204 via one or more fixed connections 264 (e.g., 264a and 264b), e.g., by welding, by fastening mechanism such as bolt and screw or the like, or a combination thereof. In examples, a stopper 260 may be attached to a side surface 262 of base portion 240. In examples, side surface 262 faces the same direction as the side of vertical web portion 238 where one or more cleats 256 are connected. In examples, as shown one or more stoppers 260 may be arranged to be on one or more lateral sides of an anti-lift system when the profile wire screen panel 202 is connected to support beam 204. In examples, as shown one or more stoppers 260 may be arranged or provided to abut to anti-lift bar 250 and/or connection plate 252 of a profile wire screen panel 202 when the profile wire screen panel 202 is connected to support beam 204.

FIG. 3C illustrates a plan view of a bottom portion beam-panel connections 214c and 214f to further illustrate the arrangement of the anti-lift bars 250. FIG. 3C support beam 204c with vertical web portion 238 and a base portion 240. For case of illustration, FIG. 3C omits cleats 256, cover plate 242, and the profile wire screen panels 202c and 202d except for the anti-lift bars 250 and the connection plates 252. As shown, attached to base portion 240 are one or more stoppers 260 (e.g. 260a, 260b, 260c, and 260d). FIG. 3C also illustrates respective connection plates 252c and 252d that may be connected to one or more support bars 226 of profile wire screen panels 202c and 202d. FIG. 3C further illustrates anti-lift bars 250c and 250d of profile wire screen panels 202c and 202d respectively. As shown, each anti-lift bar 250c and 250d may be connected to respective connection plate 252c and 252d by respective fixed connections 254c and 254d. Also, as shown, each anti-lift bar 250 may be configured to extent over a bottom surface of base portion 240 of support beam 204c.

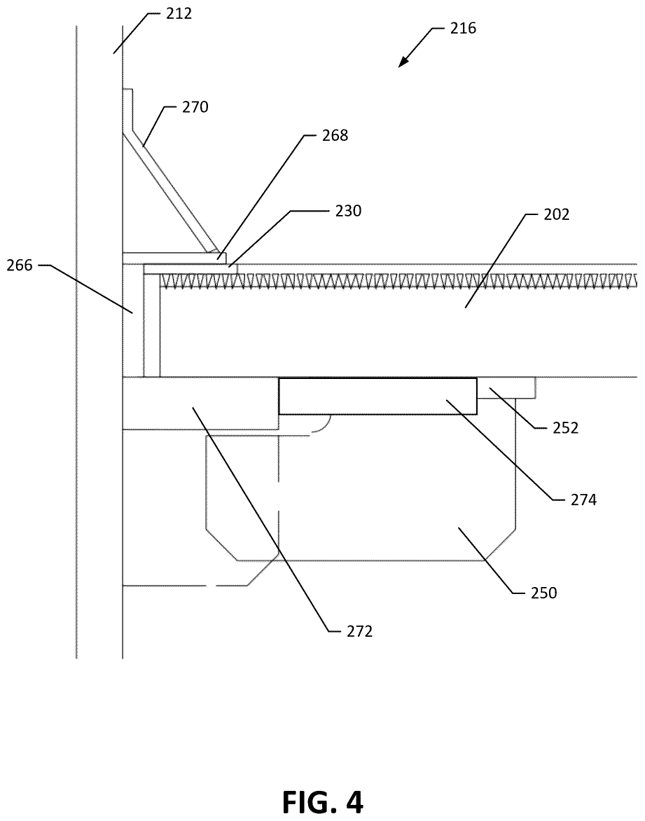

FIG. 4 illustrates a longitudinal end connection 216 provided at longitudinal end portion 210 of the floating support grid system 200 where a profile wire screen panel 202 is directly connected to a portion 212 of a horizontal ammonia converter basket instead of a support beam 204. In examples, longitudinal end connection 216 may also be configured to leave a panel end gap 266 between an edge portion 244a or 244b of profile screen wire panel 202 and portion 212. In examples, panel edge gap 266 may extend between the profile wire screen panel 202 and portion 212 connected thereto along the full length of lateral side edge 244a or 244b of profile wire screen panel 202. In examples, the panel end gap 266 may be the same or similar to the previously described edge gap 234. In examples, the panel end gap 266 may range from about 6 mm (or 0.25 inch) to about 25 mm (or 1 inch).

In examples, longitudinal end connection 216 may include an end portion cover plate 268 that is similar to previously described cover plate 242 except that end portion cover plate 268 may be connected to portion 212 of the horizontal ammonia converter basket rather than a support beam 204. In examples, the end portion cover plate 268 may be configured in the same or similar manner as previously described cover plate 242. In examples, end portion cover plate 268 may be provided to prevent debris or catalyst particles provided over the top of profile wire screen panel 202 from entering panel end gap 266. In examples, end portion cover plate 268 may be configured to overlap or abut without connection a top surface of built-in plate 230 of a profile wire screen panel 202. In examples, the spacing between a bottom surface of end portion cover plate 268 facing built-in plate 230 and a top surface of built-in plate 230 facing the end portion cover plate 268 may be less than a diameter of a catalyst to be provided over profile wire screen panel 202. In examples, the spacing may be configured to impede or prevent catalyst particles or other debris from reaching panel end gap 266, as previously described with reference to cover plate 242. In examples, to maintain the size of the spacing between end portion cover plate 268 and built-in plate 230 under a desired threshold, the floating support grid system 200 may include one or more end portion cleats 270 extending from end portion 212 to a top surface of end portion cover plate 268 in the same manner previously described for cleats 256. In examples, end portion cleats 270 may be formed as brackets or may be designed as cleats 256.

In examples, longitudinal end connection 216 of floating support grid system 200 may include a base ledge 272 protruding from portion 212 at a location below end portion cover plate 268. In examples, base ledge 272 may be configured so that an edge portion of a profile screen wire panel 202 may rest thereon. In examples, when a profile wire screen panel 202 is connect to longitudinal end connection 216, an end portion of profile wire screen panel 202 is configured to slide between a bottom surface of end portion cover plate 268 and a top surface of base ledge 272.

In examples, an anti-lift bar 250 and optionally connection plate 252 of a profile screen wire panel 202 may be employed in the same manner previously described with reference to beam 204 by having anti-lift bar 250 extend over at least a portion of a bottom surface a base ledge 272 in the same manner as previously described with respect to the overlap of anti-lift bar 250 over a bottom surface of base portion 240 of a support beam 204.

In examples, one or more end portion stoppers 274 may be provided to protrude from portion 212 of the horizontal ammonia converter basket and/or from base ledge 272 to prevent lateral movement in the Y direction of an installed profile wire screen panel 202. In examples, end portion stoppers 274 may be configured and arranged in the same manner as previously described stoppers 260 except that end portion stoppers 274 may be connected to portion 212 instead of being connected to a base portion 240 of a support beam 204.

In examples, the floating support grid system 200 may be configured to include and/or define one or more gaps or spacings to accommodate, at least in part, any lateral movement of one or more portions of floating support grid system 200 due to thermal expansion.

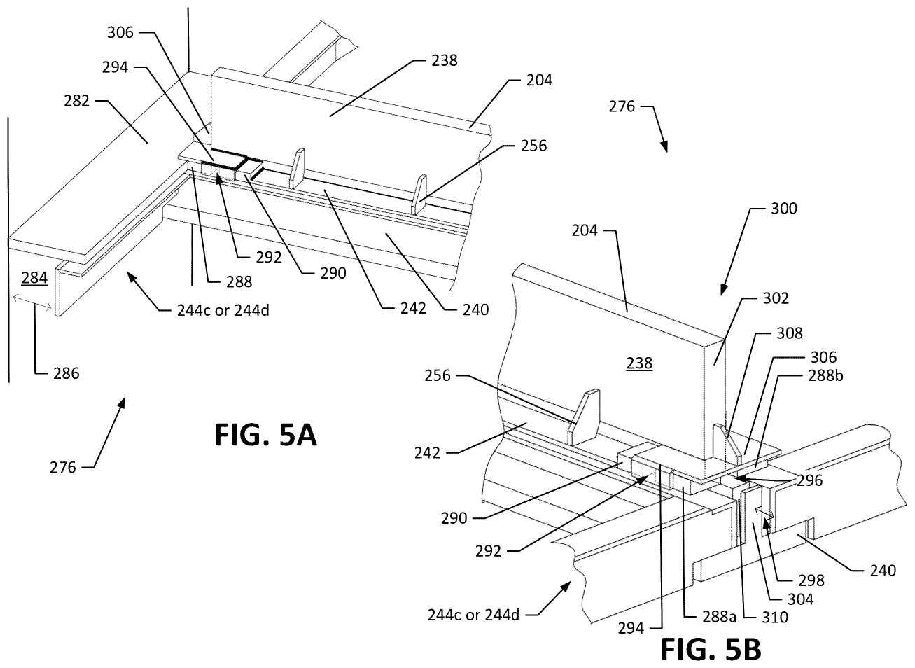

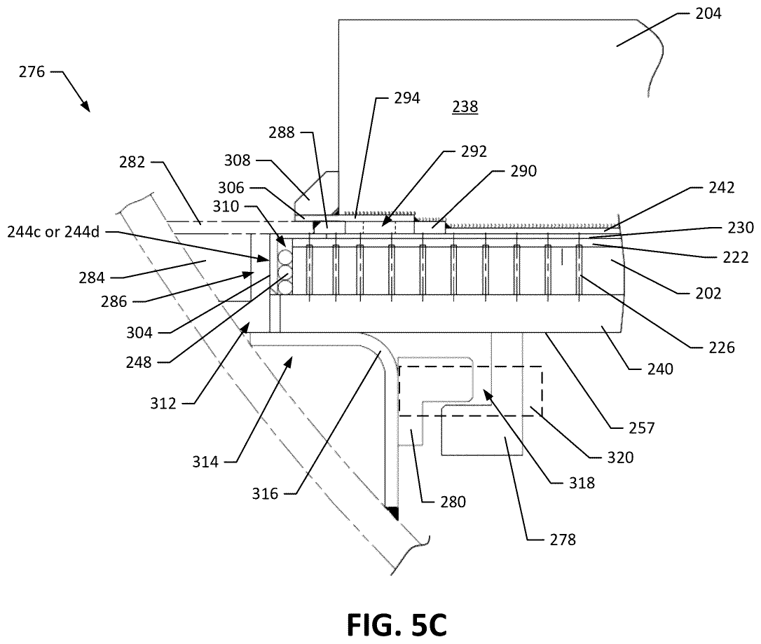

In examples, as shown in FIGS. 5A-5C, the floating support grid system 200 may include a lateral ledge 282 configured to extend from a portion of horizontal ammonia converter basket along a lateral end portion of floating support grid system 200. In examples, lateral ledge 282 may be provided as an integral part of horizontal ammonia converter basket. In examples, lateral ledge 282 can be fixed joint, e.g., by welding or a mechanical fastener such as bolt and screw or the like, or any combination thereof, to the horizontal ammonia converter basket. In examples, a lateral ledge 282 may be provided on either longitudinal side edge 244c and 244d of floating support grid system 200. In examples, a lateral ledge 282 may be provided on both longitudinal side edges 244c and 244d of floating support grid system 200. The description that follows with respect to lateral ledge 282 is equally applicable to either longitudinal side edge 244c and 244d of a floating support grid system 200.

In examples, lateral ledge 282 may be configured such that when the floating support grid system 200 is installed at least a portion of lateral ledge 282 can overlap at least a longitudinal side edge 244c or 244d (i.e. an end portion along the X direction) of one or more profile wire screen panels 202. In examples, the overlap between lateral ledge 282 and a lateral end of profile wire screen panel 202 may occur over at least a portion of a top surface of built-in plate 230 of the profile wire screen panel 202. In examples, the overlap between lateral ledge 282 and a lateral end of profile wire screen panel 202 and/or built-in plate 230 may range from about 25 mm (or 1 inch) to about 50 mm (or 2 inch). In examples, the floating support grid system 200 may be configured such that a space or panel lateral side gap 286 is formed between a longitudinal (i.e. along the X direction) side edge 244c or 244d of a profile wire screen panel 202 and aa portion of a horizontal ammonia converter basket such as a wall or other structure 284 of a horizontal ammonia converter basket. In examples, panel lateral side gap 286 may extend between the profile wire screen panel 202 and a wall or other structure 284 of a horizontal ammonia converter basket connected thereto along the full length of longitudinal side edge 244c or 244d of profile wire screen panel 202. In examples, as illustrated in FIG. 5C, wall or structure 284 of a horizontal ammonia converter basket may include a bracket or like structure below lateral ledge 282. This is just an example of structure 284 as other structures may be provided. For case of illustration, FIGS. 5A and 5B illustrate only longitudinal side edges 244c and 244d of two profile wire screen panels 202. In examples, panel lateral side gap 286 may be configured to accommodate a thermal expansion movement in the Y direction of a profile wire screen panel 202. In examples, panel lateral side gap 286 may be configured to accommodate movement in the Y direction of a profile wire screen panel 202 caused by the lateral thermal expansion of one or more support beams 204. In examples, a ceramic rope, similar to previously described ceramic rope 248, may be provided in panel lateral side gap 286. In examples, as a support beam 204 expands in the lateral direction, it may cause movement of a connected profile wire screen panel 202 because of the one or more stoppers 260 that may be configured to maintain lateral alignment between profile wires screen panels 202 and support beams 204. As such, a panel lateral side gap 286 may be helpful to accommodate such lateral movement of one or more profile wire screen panels 202.

In examples, a floating support grid system 200 may include one or more second floating connection, referred to herein as beam floating lateral connection 276 between support beams 204 and the horizontal ammonia converter basket. In examples, a beam floating lateral connection 276 may include an anti-lift connection. In examples, as shown in FIG. 2B, every support beam 204 in floating support grid system 200 may be connected to the horizontal ammonia converter basket. In examples, a support beam 204 may be connected to the horizontal ammonia converter basket at a lateral end portion 218 and/or 220 as illustrated earlier with reference to FIG. 2A. In examples, a support beam 204 may be connected to the horizontal ammonia converter basket at both lateral end portions 218 and 220. In examples, each support beam 204 of floating support grid system 200 may be connected to the horizontal ammonia converter basket at both respective lateral end portions 218 and 220 of floating support grid system 200. In examples, a connection between a support beam 204 and the horizontal ammonia converter basket may include a beam floating lateral connection 276.

FIGS. 5A and 5B provide perspective views of a beam floating lateral connection 276. In examples, every connection between every support beam 204 and the horizontal ammonia converter basket may include a beam floating lateral connection 276.

In examples, a beam floating lateral connection 276 may define and/or include one or more gaps between a support beam 204 and a horizontal ammonia converter basket when the support beam is connected to the horizontal ammonia converter basket. In examples, each of the one or more gaps defined and/or included in a beam floating lateral connection 276 may be configured to allow for or accommodate for a thermal expansion movement in the width or Y direction of support beam 204, a profile wire screen 202, or both.

In examples, a beam floating lateral connection 276 may define and/or include one or more beam connection spacing or gaps configured to allow for a thermal expansion movement of a support beam 204 in a Y direction of the floating support grid system 200. In examples, beam floating lateral connection 276 may include one or more cover plates to prevent or hinder catalyst that is to be loaded on a profile wire screen panel 202 from entering the one or more beam connection spacing or gaps. In examples, the beam cover plates may be formed of any suitable material. In examples, beam cover plates may include the same or different material as support beam 204. In examples, beam cover plates may include a metal or metal alloy, for example steel.

In examples, as shown in FIGS. 5A and 5B, a beam floating lateral connection 276 of a floating support grid system 200 may include one or more lateral ledge plates 288. In FIG. 5B, lateral ledge 282 is not shown for ease of illustration. In examples, a lateral ledge plate 288 may be fixed connected to a lateral ledge 282. In examples, a lateral ledge plate 288 may be connected to a lateral ledge 282 by a welded joint, mechanical fastener such as by bolt and screw or like mechanism, or a combination thereof. In examples, lateral ledge plate 288 may be arranged to laterally extend from lateral ledge 282. In examples, lateral ledge plate 288 may be arranged to extend from lateral ledge 282 towards the center of floating support grid system 200 and/or of a support beam 204.

In examples, a beam floating lateral connection 276 of a floating support grid system 200 may include one or more abutting plates 290. In examples, an abutting plate 290 may be fixed connected to a support beam 204. In examples, the fixed connection may be a welded joint, mechanical fastener such as by bolt and screw or like mechanism, or a combination thereof. In examples, an abutting plate 290 may be provided at a lateral end portion of a support beam 204. In examples, an abutting plate 290 may be provided at a lateral end portion of a cover plate 242 of a support beam 204. In examples, an abutting plate 290 may be an integral portion of cover plate 242 and/or fixed connected to cover plate 242. In examples, the fixed connection may be a welded joint, mechanical fastener such as by bolt and screw or like mechanism, or a combination thereof.

In examples, lateral ledge plate 288 and abutting plate 290 may include any suitable material. In examples, lateral ledge plate 288 and abutting plate 290 may include the same or different material. In examples, lateral ledge plate 288 and abutting plate 290 may include the same or different material as lateral ledge 282, support beam 204, or both. In examples, each of lateral ledge plate 288 and abutting plate 290 may independently include a metal or metal alloy, for example steel.

In examples, a lateral ledge plate 288 and an abutting plate 290 may be configured to be aligned. In examples, a lateral ledge plate 288 and an abutting plate 290 have a matching or the same or different cross-sectional shape and/or size. In examples, lateral ledge plate 288 and abutting plate 290 may be configured such that when a lateral end of a support beam 204 is connected to the horizontal ammonia converter basket, a beam lateral side gap 292 may be defined between and aligned with lateral ledge plate 288 and abutting plate 290. In examples, beam lateral side gap 292 may be configured to accommodate lateral movement of a support beam 204. In examples, the lateral movement may be due to thermal expansion. In examples, the size of beam lateral gap 292 may range from about 12 mm (or 0.5 inch) to about 25 mm (or 1 inch).

In examples, floating support grid system 200 may include a seal plate 294. In examples, seal plate 294 may be fixed connected to lateral ledge plate 288. In examples, seal plate 294 may be an integral portion of lateral ledge plate 288. In examples, seal plate 294 may be fixed connected to abutting plate 290 and/or support beam 204. In examples, seal plate 294 may be an integral portion of abutting plate 290, cover plate 242, and/or of support beam 204. In examples, the fixed connection may be a welded joint, mechanical fastener such as by bolt and screw or like mechanism, or a combination thereof. In examples, seal plate 294 may be configured to overlap, i.e. extend over, at least a portion of ledge plate 288, abutting plate 290, or both. In examples, the overlap between seal plate 294 and either ledge plate 288 and/or abutting plate 290 may be at least about 20 mm.

In examples, seal plate 294 may be configured to extend over beam lateral side gap 292. In examples, seal plate 294 may be configured to cover the top and side of a beam lateral side gap 292. In examples, seal plate 294 may be configured to extend from over beam lateral side gap 292 to a top surface of cover plate 242 of support beam 204 and/or built-in plate 230 of a profile wire screen panel 202 connected to the support beam 204. In examples, seal plate 294 may be configured to seal a beam lateral side gap 292 from catalyst or other solid debris. In examples, seal plate 294 may be configured to prevent or impede catalyst or other debris from entering lateral side gap 292.

In examples, seal plate 294 may be configured to slide over lateral ledge plate 288 and/or abutting plate 290. In examples, seal plate 294 may be configured to maintain its function as it slides over lateral ledge plate 288 and/or abutting plate 290. In this manner, as support beam 204 lateral moves due to thermal expansion seal plate 294 is configured to slide to avoid hindering or significantly hindering the movement that is being accommodated by beam lateral side gap 292.

In examples, a floating support grid system 200 may include at least one arrangement of a lateral ledge plate 288, abutting plate 290, and seal plate 294 as described at a beam floating lateral connection 276 of a support beam 204. In examples, a floating support grid system 200 may include two arrangements of a lateral ledge plate 288, abutting plate 290, and seal plate 294 as described at a beam floating lateral connection 276 of a support beam 204. In examples, each of a lateral ledge plate 288, abutting plate 290, and seal plate 294 may be provided on each side of a vertical web portion 238 of a lateral end portion of a support beam 204. In these latter examples, where a seal plate 294 would be provided on both longitudinal sides on a lateral end portion of a vertical web portion 238, the two seal plates 294 may be implemented as two separate seal plates or a single integral seal plate that extends from one side of vertical web portion 238 to the other side of vertical web portion 238 as for example illustrated in FIGS. 5A and 5B. In examples, a floating support grid system 200 may include at least one arrangement of a lateral ledge plate 288, abutting plate 290, and seal plate 294 as described at both lateral connections of a support beam 204. In examples, a floating support grid system 200 may include two arrangements of a lateral ledge plate 288, abutting plate 290, and seal plate 294 as described at both lateral connections of a support beam 204. In examples, each of a lateral ledge plate 288, abutting plate 290, and seal plate 294 may be provided on each side of a vertical web portion 238 of both lateral end portions of a support beam 204.

In examples, as shown in FIGS. 5A and 5B, beam floating lateral connection 276 may define and/or include one or more support beam web lateral end gaps 296 and 298 between a lateral end portion 300 of support beam 204 and the horizontal ammonia converter basket and/or a wall or structure 284 thereof. In examples, support beam web lateral end gaps 296 and 298 may each independently range from about 25 mm (or 1 inch) to about 50 mm (or 2 inch). The wall or other structure 284 of the horizontal ammonia converter basket is not illustrated in FIG. 5B for clarity. In examples, vertical web portion 238 may include a stepped profile at a lateral end portion 300 of a support beam 204. In examples, the stepped profile of vertical web portion 238 at lateral end portion 300 of a support beam 204 may include an upper vertical surface 302 and a lower vertical surface 304. In examples, upper and lower vertical surfaces 302 and 304 can face the horizontal ammonia converter basket and/or wall or structure thereof at a location where support beam 204 is laterally connected thereto. In examples, the stepped profile of vertical web portion 238 may be configured such that upper vertical surface 302 is recessed with respect to lower vertical surface 304. In examples, the stepped profile of vertical web portion 238 may be configured such that when support beam 204 is connected to a horizontal ammonia converter basket, upper vertical surface 302 is at location that is spaced from and faces lateral ledge 282 while lower vertical surface 304 is located below lateral ledge 282.

In examples, a first beam web lateral end gap 296 may be provided between a lateral end portion 300 of a support beam 204 and a lateral ledge 282. In examples, a first beam web lateral end gap 296 may be between vertical web portion 238 and lateral ledge 282. In examples, a first beam web lateral end gap 296 may be formed between the upper vertical surface 302 of vertical web portion 238 and a lateral ledge 282. In examples, the floating support grid system 200 may be configured such that a beam floating lateral connection 276 as the support beam 204 expands, upper vertical surface 302 can move towards lateral ledge 282. In examples, floating support grid system 200 may include one or more support beam lateral end covers 306 extending from upper vertical surface 302 of vertical web portion 238. In examples, a support beam lateral end cover 306 may be configured to extend over and thus cover first beam web lateral end gap 296. In examples, a support beam lateral end cover 306 may be configured to extend over at least a portion of lateral ledge 282. In examples, the overlap of a support beam lateral end cover 306 and lateral ledge 282 may range from about 25 mm (or 1 inch) to about 50 mm (or 2 inch). In this manner, as the support beam 204 moves in a lateral direction because of thermal expansion support beam lateral end cover 306 can slide over lateral ledge 282. In examples, a support beam lateral end cover 306 may be configured to prevent or impede catalyst and/or debris from entering first beam web lateral end gap 296.

In examples, a support beam lateral end cover 306 may include the same or different material as support beam 204, seal plate 294, or both. In examples, support beam lateral end cover 306 may include a metal or metal alloy, for example steel. In examples, a support beam lateral end cover 306 may be welded to support beam 204 and/or vertical web portion 238. In examples, support beam lateral end cover 306 may be separate structure from one or more seal plates 294. In examples, support beam lateral end cover 306 may be fixed connected such by welding and/or by a mechanical fastener to one or more seal plates 294. In examples, as shown in FIGS. 5A-5C, a support beam lateral end cover 306 may be part of an integral structure that also includes one or more seal plates 294.

In examples, one or more support beam lateral end cleats 308 may be provided extending from upper vertical surface 302 of vertical web portion 238 to a top surface of support beam lateral end cover 306. In examples, a support beam lateral end cleats 308 may be configured in the same manner as one or more cleats 256 previously described. In examples, a support beam lateral end cleat 308 may be configured to ensure that a spacing between support beam lateral end cover 306 and a top surface of lateral ledge 282 overlapped by the support beam lateral end cover 306 is sufficiently small to prevent or impede catalyst or other debris from entering first beam web lateral end gap 296.

In example, a second beam web lateral end gap 298 may be provided between a lower vertical face 304 of vertical web portion 238 of support beam 204 and a wall or other structure 284 (not shown in FIG. 5B) of a of a horizontal ammonia converter basket. In examples, a second beam web lateral end gap 298 may be configured to be below lateral ledge 282 when support beam 204 is connected to the horizontal ammonia converter basket. In examples, the second support beam web lateral end gap 298 may be configured to accommodate for lateral movement of support beam 204 caused by thermal expansion. In examples, the floating support grid system 200 may be configured such that a beam floating lateral connection 276 as the support beam 204 expands, lower vertical face 304 under lateral ledge 282 may move towards a wall or other structure 284 of a horizontal ammonia converter basket.

As also shown in FIG. 5B, in examples, the vertical web portion 238 may include a notch or passthrough 310 at one or more lateral end portions 300 thereof. In examples, notch or passthrough 310 may be formed by grinding, cutting or like manner, or alternatively may be provided by attaching a vertical tab extending vertically from base 240 in front of and spaced from vertical web portion 238. In examples, notch or passthrough 310 may allow for the wrapping or placement of ceramic ropes 248 previously described. In examples, ceramic ropes 248 may be wrapped around the full lateral length of vertical web portion 238 at a position where edge gaps 234 are to be provided. In examples, the ceramic ropes 248 may extend from one lateral side of vertical web portion 238 to the other opposite lateral side of vertical web portion 238 by wrapping around lateral end portion 300 through notch or passthrough 310 as also illustrated in FIG. 5C.

FIG. 5C illustrates a side view of beam floating lateral connection 276 as described with reference to FIGS. 5A and 5B.

In examples, as shown in FIG. 5C, a beam floating lateral connection 276 of floating support grid system 200 may be configured to provide a support beam base lateral end gap 312. In examples, a support beam base lateral end gap 312 may range from about 12 mm (or 0.5 inch) to about 25 mm (or 1 inch). In examples, a support beam base lateral end gap 312 may be provided between a lateral end 314 of base portion 240 of support beam 204 and a wall or other structure 284 of a horizontal ammonia converter basket in which the floating support grid system 200 is to be installed. In examples, as shown in FIG. 5C, support beam base lateral end gap 312 may be contiguous with panel lateral side gap 286. In examples, as illustrated in FIG. 5C, at beam floating lateral connection 276, the lateral end 314 of base portion 240 may be configured to rest on a support 316. In examples, support 316 may be fixed connected to and/or an extension of a horizontal ammonia converter basket. In examples, base portion 240 of support beam 204 may be configured such that when lateral end 314 rests on support 316, a support beam base lateral end gap 312 may be defined between base portion 240 and a wall or other structure 284 of a horizontal ammonia converter basket. In examples, support beam base lateral end gap 312 may be configured to accommodate for lateral movement of support beam 204 due to thermal expansion.

In examples, as also illustrated in FIG. 5C, a beam floating lateral connection 276 may include a beam anti-lift bar 278. In examples, beam anti-lift bar 278 may extend from a bottom surface 257 of base portion 240 of support beam 204. In examples, beam anti-lift bar 278 may be fixed connection to support beam 204 and/or base portion 240. In examples, the fixed connection may be via a welded joint, a mechanical fastener such as bolt and screw or like structure, or a combination thereof. In examples, beam anti-lift bar 278 may include an L-shape profile. In examples, beam anti-lift bar 278 may be configured to reach below a mating structure 280 that is fixed connected to and/or an extension of a horizontal ammonia converter basket. By this arrangement, beam anti-lift bar 278 can assist in preventing or hindering the lifting of support beam 204 and/or of floating support grid system at floating lateral connection 276. In examples, an anti-lift bar gap 318 may be defined between beam anti-lift bar 278 and mating structure 280 when support beam 204 is connected to the horizontal ammonia converter basket. In examples, anti-lift bar gap 318 may be configured to accommodate for lateral movement of support beam 204 caused by thermal expansion. In examples, anti-lift bar gap 318 may range from about 25 mm (or 1 inch) to about 50 mm (or 2 inch). In examples, one or more beam stoppers 320 (e.g., 320a, 320b, etc. . . . ) (shown in FIG. 5C broken line for clarity, and also shown in FIG. 2B) may be provided so as to be on one or both sides of anti-lift bar 278 when support beam 204 is connected to the horizontal ammonia converter basket. In examples, the one or more beam stoppers 320 may prevent movement in the longitudinal direction X of support beam 204. In examples, beam stopper 320 may be designed in the same manner as previously described stoppers 260 and 274. In examples, beam stoppers 320 may be fixed connected, i.e. welded or mechanically fastened to the horizontal ammonia converter basket or portion thereof, for example to support 316 as shown in FIG. 5C.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A floating support grid system comprising:
a plurality of support beams;
a plurality of profile wire screen panels;
a plurality of first connections each connecting one support beam of the plurality of support beams to one profile wire screen panel of the plurality of profile wire screen panels, wherein, at least one first connection of the plurality of first connections comprises a first floating connection configured to define a first gap between the one support beam of the plurality of support beams and the one profile wire screen panel of the plurality of wire screen panels the at least one first connection connects; and
a plurality of second floating connections each configured to connect a support beam of the plurality of support beams to a horizontal ammonia converter basket.

2. The floating support grid system of claim 1, wherein the first gap is configured to accommodate a thermal expansion movement of a profile wire screen panel, a support beam, or both.

3. The floating support grid system of claim 1, wherein each first floating connection connects one side of the one profile wire screen panel to one side of the one support beam.

4. The floating support grid system of claim 1, wherein at least one profile wire screen panel of the plurality of profile wire screen panels is connected to a first support beam of the plurality of support beams at a first lateral side of the at least one profile wire screen panel and is connected to a second support beam of the plurality of support beams at a second lateral side, opposite the first lateral side, of the at least one profile wire screen panel.

5. The floating support grid system of claim 4, wherein one first floating connection is provided to connect the first support beam with the at least one profile wire screen panel at the first lateral side, and another first floating connection is provided to connect the second support beam with the at least one profile wire screen panel at the second lateral side.

6. The floating support grid system of claim 1, wherein every first connection comprises a first floating connection.

7. The floating support grid system of claim 1, wherein each profile wire screen panel of the plurality of wire screen panels comprises:
a wire grid comprises one or more wires;
at least one support bar provided below the wire grid; and
a built-in plate over a peripheral area of the wire grid.

8. The floating support grid system of claim 7, the first floating connection further comprising a first cover plate configured to overlap at least a portion of the built-in plate over the peripheral area of the wire grid of the one profile wire screen panel connected to the one support beam, wherein the first cover plate extends from the one support beam toward the one profile wire screen panel connected to the one support beam.

9. The floating support grid system of claim 8, further comprising one or more cleats extending from a vertical web portion of the one support beam connected to the one profile wire screen panel to a top surface of the first cover plate.

10. The floating support grid system of claim 1, wherein the first floating connection further comprises a first anti-lift system, wherein the first anti-lift system comprises an anti-lift bar fixed connected to a bottom surface the one profile wire screen panel, the anti-lift bar configured to extend below a bottom surface of a base portion of the one support beam connected to the one profile wire screen panel.

11. The floating support grid system of claim 10, further comprising one or more stoppers extending from the base portion of the one support beam connected to the one profile wire screen panel, the one or more stoppers arranged to be on one or more lateral sides of the first anti-lift system to prevent lateral movement of the one profile wire screen panel relative to the one support beam connected thereto.

12. The floating support grid system of claim 1, further comprising one or more third floating connections configured to connect at least one profile wire screen panel of the plurality of wire screen panels to the horizontal ammonia converter basket, wherein each third floating connection is configured to define a third gap between the at least one profile wire screen panel and a third or fourth portion of the horizontal ammonia converter basket it is configured to connect when the at least one profile wire screen panel is connected to the horizontal ammonia converter basket.

13. The floating support grid system of claim 12, wherein the third gap is configured to accommodate a thermal expansion movement of the at least one profile wire screen, a support beam of the plurality of support beams, or both.

14. The floating support grid system of claim 12, wherein every third floating connection comprises:
a second cover plate arranged to extend over the third gap defined by third floating connection; and
a second anti-lift system.

15. The floating support grid system of claim 1, wherein at least one second floating connection of the plurality of second floating connections is configured to define one or more second gaps between the support beam of the plurality of support beams and a second one or more portions of the horizontal ammonia converter basket when the at least one second floating connection connects a lateral end of the support beam of the plurality of support beams to the horizontal ammonia converter basket.

16. The floating support grid system of claim 15, wherein each of the one or more second gaps is configured to independently accommodate a thermal expansion movement of the support beam of the plurality of support beams, a profile wire screen panel of the plurality of profile wire screen panels, or both.

17. The floating support grid system of claim 15, wherein the support beam of the plurality of support beam comprises a first lateral end and a second lateral end, opposite the first lateral end, and wherein one second floating connection is arranged to connect the first lateral end to the horizontal ammonia converter basket and another second floating connection is arranged to connect the second lateral end to the horizontal ammonia converter basket.

18. The floating support grid system of claim 15, wherein every support beam of the plurality of support beams comprises a respective first lateral end with a respective second floating connection and a second lateral end, opposite the first lateral end, with a respective second floating connection, wherein every first lateral end and every second lateral end are connected to the horizontal ammonia converter basket.

19. The floating support grid system of claim 15, wherein the second floating connection is configured to define a panel lateral side gap between a profile wire screen panel connected to the support beam of the plurality of support beams and one of the second portions of the horizontal ammonia converter basket.

20. The floating support grid system of claim 19, wherein the panel lateral side gap is below a lateral ledge fixed connected to the horizontal ammonia converter basket.

21. The floating support grid system of claim 15, wherein the second floating connection further comprises one or more abutting plates each fixed connected to the support beam of the plurality of support beams and one or more lateral ledge plate extending form a lateral ledge fixed connected to the horizontal ammonia converter basket, wherein each abutting plate is aligned with a lateral ledge plate and configured to define a respective beam lateral side gap when the support beam of the plurality of support beams is connected to the horizontal ammonia converter basket.

22. The floating support grid system of claim 21, further comprising one or more second cover plates, each second cover plate configured to cover the respective beam lateral side gap.

23. The floating support grid system of claim 22, wherein the respective second cover plate is configured to overlap with at least a portion of the respective lateral ledge plate and to slide over the respective lateral ledge plate.

24. The floating support grid system of claim 23, wherein the second floating connection provided at a lateral end of a support beam comprises two abutting plates and two lateral ledge plates, wherein the two abutting plates and the two lateral ledge plates are arranged to define two separate beam lateral side gaps.

25. The floating support grid system of claim 24, further comprising an integral cover plate arranged to cover both separate beam lateral side gaps and extending over both lateral ledge plates.

26. The floating support grid system of claim 15, wherein the second floating connection is configured to define a first beam web lateral end gap between a vertical web portion of the support beam and a lateral ledge fixed connected to the horizontal ammonia converter basket.

27. The floating support grid system of claim 26, further comprising a third cover plate covering the first beam web lateral gap, wherein the third cover plate is configured to slide over the lateral ledge.

28. The floating support grid system of claim 15, wherein the second floating connection is configured to define a second beam web lateral gap between a vertical web portion of the support beam and one of the second portions of the horizontal ammonia converter basket, wherein the second beam web lateral gap is below a lateral ledge fixed connected to the horizontal ammonia converter basket.

29. The floating support grid system of claim 15, wherein the second floating connection is configured to define a support beam base lateral end gap between a base portion of the support beam and one of the second portions of the horizontal ammonia converter basket.

30. The floating support grid system of claim 15, wherein the second floating connection is configured to define an anti-lift bar gap between an anti-lift bar connected to a base portion of the support beam and a mating structure connected to the horizontal ammonia converter basket.

31. A floating support grid system comprising:
a plurality of support beams, each support beam comprising a first lateral end and a second lateral end, opposite the first lateral end;
a plurality of profile wire screen panels each connected via a respective first floating connection to at least one support beam of the plurality of support beams, each profile wire screen panel comprising:
a first lateral side edge and a second lateral side edge;
a first longitudinal side edge and a second longitudinal side edge;
a grid comprising one or more wires; and
a built-in plate over a peripheral area of the grid;
one second floating connection configured to connect a first lateral side edge of a first profile wire screen panel to a horizontal ammonia converter basket;
another second floating connection configured to connect a second lateral side edge of a second profile wire screen panel to the horizontal ammonia converter basket; and
a third floating connection provided at each first lateral end of each support beam and at each second lateral end of each support beam, wherein the third floating connection is configured to connect each respective first lateral end and second lateral end to the horizontal ammonia converter basket,
wherein, each first floating connection is configured to define a first gap between each profile wire screen panel and respective support beam to which it is connected,
wherein, each second floating connection is configured to define a second gap between the respective first lateral side edge or second lateral side edge and a first or second portion of the horizontal ammonia converter basket,
wherein each third floating connection is configured to define respectively one or more third gaps between the first lateral end of each support beam and one or more third portions of the horizontal ammonia converter basket, between the second lateral end of each support beam and one of the third portions of the horizontal ammonia converter basket, between the first longitudinal side edge of each profile wire screen panel and one of the third portions of the horizontal ammonia converter basket, and between the second longitudinal side edge of each profile wire screen panel and one of the third portions of the horizontal ammonia converter basket, and
wherein the first gap, the second gap, and the one or more third gaps are configured to accommodate a thermal expansion movement of one or more support beams, profile wire screen panels, or both.

32. A horizontal ammonia converter comprising:
a horizontal ammonia converter basket; and
a floating support grid system of claim 1.
